(19) United States
(12) Patent Application Publication
(10) Pub. No.: US 2020/0041746 A1
(43) Pub. Date: Feb. 6, 2020

(54) LENS MODULE

(71) Applicant: AAC Technologies Pte. Ltd., Singapore city (SG)

(72) Inventor: Chuandong Wei, Shenzhen (CN)

(21) Appl. No.: 16/524,207

(22) Filed: Jul. 29, 2019

(30) Foreign Application Priority Data
Aug. 2, 2018 (CN) 201821252842.6

(51) Int. Cl. G02B 7/02; G02B 13/00

(52) U.S. Cl. CPC G02B 7/021; G02B 7/026; G02B 13/0045

(57) ABSTRACT

A lens module includes a lens barrel; and a lens arranged inside the lens barrel. The lens barrel includes: a first barrel wall extending from an object side towards an image side; a second barrel wall arranged at an image side of the first barrel wall and having an inner diameter greater than that of the first barrel wall; and a connection wall connecting the first and second barrel walls. The lens includes: an optical portion for imaging; and a peripheral portion surrounding the optical portion. The peripheral portion includes a first abutting portion close to the object side, and a second abutting portion close to the image side and connected to the first abutting portion. An outer diameter of the second abutting portion is greater than that of the first abutting portion. The first and second abutting portions are received within the first and second barrel walls, respectively.

### TECHNICAL FIELD

The present disclosure relates to the technical field of optical lenses, and in particular, to a lens module.

### BACKGROUND

In recent years, with development of imaging technologies and rising of electronic products with imaging functions, optical imaging lenses have been widely used in various electronic products, and have been continuously improved and optimized. At present, lenses in a lens module are generally assembled by stacking. A lens abuts against another lens, a lens abuts against a lens barrel, and the lens is restrained in the lens barrel by a press-ring glued on an inner wall of the lens barrel.

The inventor of the present disclosure realized that in the related art, in order to enable a lens having the greatest outer diameter in the lens module to be installed into the lens barrel, the lens barrel needs to have a size at least greater than a size of the biggest lens, which goes against miniaturization of the overall lens module.

### BRIEF DESCRIPTION OF DRAWINGS

Many aspects of the exemplary embodiment can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a schematic structural cross-sectional view of a lens module according to a first embodiment of the present disclosure;

FIG. 2 is a structural schematic cross-sectional view of a lens of the lens module according to the first embodiment of the present disclosure;

FIG. 3 is a structural schematic cross-sectional view of a lens barrel of the lens module according to the first embodiment of the present disclosure;

FIG. 4 is a schematic structural cross-sectional view of a lens module according to a second embodiment of the present disclosure;

FIG. 5 is a schematic enlarged view of a portion A of FIG. 4;

FIG. 6 is a structural schematic cross-sectional view of a lens of the lens module according to the second embodiment of the present disclosure; and

FIG. 7 is a structural schematic cross-sectional view of a lens barrel of the lens module according to the second embodiment of the present disclosure.

### DESCRIPTION OF EMBODIMENTS

The present disclosure will be further illustrated with reference to the accompanying drawings and the embodiments.

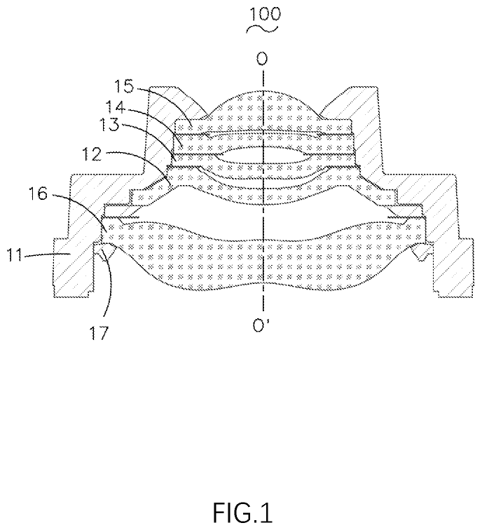

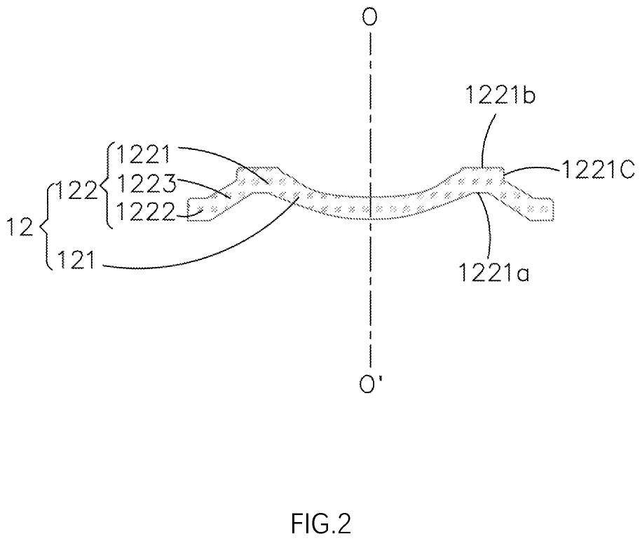

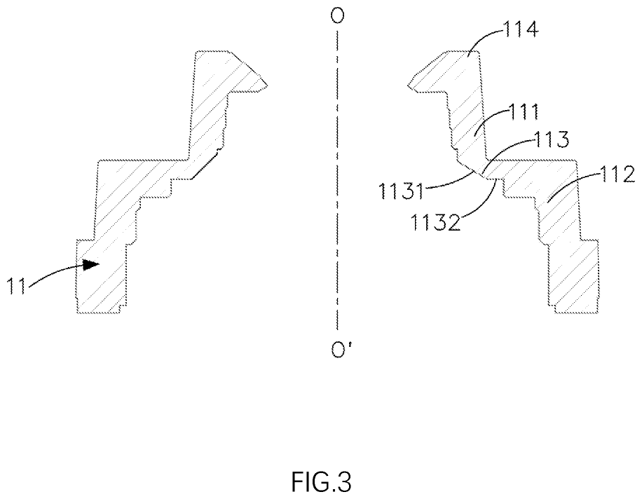

An embodiment of the present disclosure provides a lens module 100. As shown in FIGS. 1-3, the lens module 100 includes a lens barrel 11 and a lens 12. The lens 12 is arranged inside the lens barrel 11. The lens barrel 11 includes a first barrel wall 111, a second barrel wall 112, and a connection wall 113 connecting the first barrel wall 111 with the second barrel wall 112. The first barrel wall 111 extends in a direction from an object side toward an image side. The second barrel wall 112 is arranged at the image side of the first barrel wall 111, and an inner diameter of the second barrel wall 112 is greater than an inner diameter of the first barrel wall 111. The lens 12 includes an optical portion 121 and a peripheral portion 122. The optical portion 121 is used for imaging, and the peripheral portion 122 surrounds the optical portion 121. The peripheral portion 122 includes a first abutting portion 1221 and a second abutting portion 1222. The first abutting portion 1221 is close to the object side of the peripheral portion 122 and the second abutting portion 1222 is close to the image side of the peripheral portion 122. An outer diameter of the second abutting portion 1222 is greater than an outer diameter of the first abutting portion 1221. The first abutting portion 1221 is received within the first barrel wall 111, and the second abutting portion 1222 is received within the second barrel wall 112.

In this embodiment of the present disclosure, the first barrel wall 111 extends in the direction from the object side towards the image side, the second barrel wall 112 is arranged at the image side of the first barrel wall 111, the inner diameter of the second barrel wall 112 is larger than the inner diameter of the first barrel wall 111, and the first barrel wall 111 is connected to the second barrel wall 112 through the connection wall 113. Therefore, compared with the related art, in which the inner diameter of the lens barrel 11 is greater than the outer diameter of the lens having the greatest effective diameter received in the lens barrel, a head portion of the lens barrel 11 according to this embodiment of the present disclosure, i.e., the first barrel wall 111, can be made smaller. Meanwhile, in this embodiment, the peripheral portion 122 of the lens 12 is designed to include the first abutting portion 1221 and the second abutting portion 1222 having the outer diameter greater than that of the first abutting portion 1221, and the first abutting portion 1221 is received within the first barrel wall 111 and the second abutting portion 1222 is received within the second barrel wall 112. In this way, the lens 12 can be received in two receiving spaces of the first barrel wall 111 and the second barrel wall 112, which can compensate for a deficiency in the related art that a receiving space at the connection portion where the first barrel wall 111 is connected to the second barrel wall 112 cannot receive the lens due to different inner diameters. Moreover, the lenses inside the lens barrel 11 are more compact, space utilization of the lens barrel 11 can be improved, and the size of the lens barrel 11 received reduced, thereby facilitating miniaturization of the lens module 100.

It should be noted that the lens module 100 further includes a third barrel wall 114 extending from the first barrel wall 111 along a direction perpendicular to and facing towards an optical axis OO′. The third barrel wall 114 defines a light aperture close to the object side of the lens barrel 11, and the light aperture allows light to enter.

Specifically, the first abutting portion 1221 abuts against the first barrel wall 111, and the second abutting portion 1222 abuts against the connection wall 113. In this way, the first barrel wall 111 of the lens barrel 11 provides support for the first abutting portion 1221, and the connection wall 113 of the lens barrel 11 provides support for the second abutting portion 1222, so that the lens 12 can be stably fixed inside the lens barrel 11, thereby improving reliability of the lens module 100.

For example, the second abutting portion 1222 is spaced apart from the second barrel wall 112. In this way, when the second abutting portion 1222 abuts against the connection wall 113, it can prevent the second abutting portion 1222 from being in rigid contact with or excessively pressing the second barrel wall 112, which would otherwise cause deformation or even damage of the lens 12.

The connection wall 113 includes a first inner wall surface 1131 extending from an inner circumference of the first barrel wall 111 close to the image side along a direction facing away from the optical axis OO′ and facing towards the image side, and a second inner wall surface 1132 extending from the first inner wall surface 1131 to an inner circumference of the second barrel wall 112 close to the object side along a direction perpendicular to and facing towards the optical axis OO′. The second abutting portion 1222 directly abuts against the second inner wall surface 1132. In this case, the first inner wall surface 1131 can serve as a transitional surface between the first barrel wall 111 and the second barrel wall 112, thereby facilitating cooperation of the connection wall 113 with the peripheral portion 122 to allow the lens 12 to abut against the lens barrel 11.

It should be noted that the peripheral portion 122 further includes an extension portion 1223 connecting the first abutting portion 1221 with the second abutting portion 1222. It should be understood that the extension portion 1223 may directly abut against the first inner wall surface 1131 or may be spaced apart from the first inner wall surface 1131. In this embodiment, preferably, the first inner wall surface 1131 is spaced apart from the extension portion 1223. In this way, in a case in which the first abutting portion 1221 abuts against the first barrel wall 111 and the second abutting portion 1222 abuts against the second inner wall surface 1132 of the connection wall 113 so that the lens 12 can be well fixed, it can prevent the extension portion 1223 from being in rigid contact with or excessively pressing the first inner wall surface 1131 of the connection wall 113, which would otherwise cause deformation or even damage of the lens 12.

It should be noted that the first abutting portion 1221 includes an image side surface 1221a close to the image side, and the image side surface 1221a is a planar surface. In this way, a machine suction pen can be easily pressed onto the image side surface 1221a whose surface is flat, so that the lens 12 can be installed into the lens barrel 11. Further, the first abutting portion 1221 further includes an object side surface 1221b close to the object side, and a first abutting surface 1221c abutting against the first barrel wall 111. An arc transition is arranged between the object side surface 1221b and the first abutting surface 1221c.

In addition, the lens module 100 further includes a lens 13 received within the first barrel wall 111 and arranged at the object side of the lens 12, a lens 14 arranged at the object side of the lens 13, a lens 15 arranged at the object side of the lens 14, a lens 16 received within the second barrel wall 112, and a press-ring 17 arranged at the object side of the lens 16 and used for fixing the lens 16 and the second barrel wall 11. It should be understood that there are no significant differences in effective diameters of the lens 13, the lens 14 and the lens 15, and the effective diameter of the lens 13, and there are big differences between the effective diameters of the lens 13, the lens 14 and the lens 15 and an effective diameter of the lens 16. Thus, the lens 3, the lens 14, the lens 15 and the lens 16 can be received in the first barrel wall 111 having an inner diameter smaller than that of the second barrel wall 112, thereby achieving miniaturization of the head portion of the lens module 100.

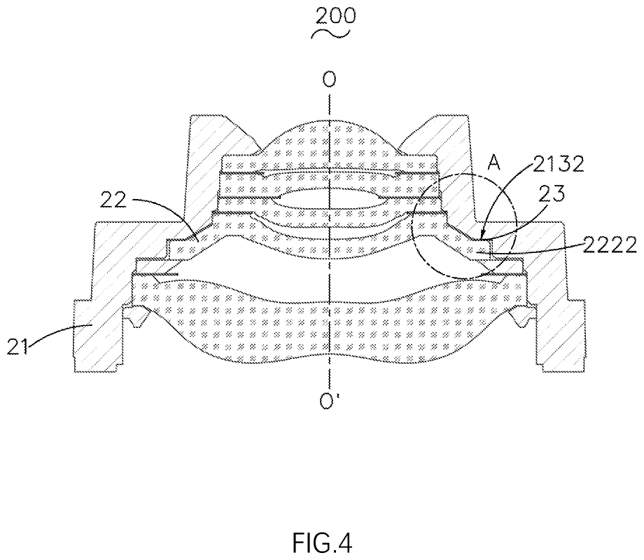

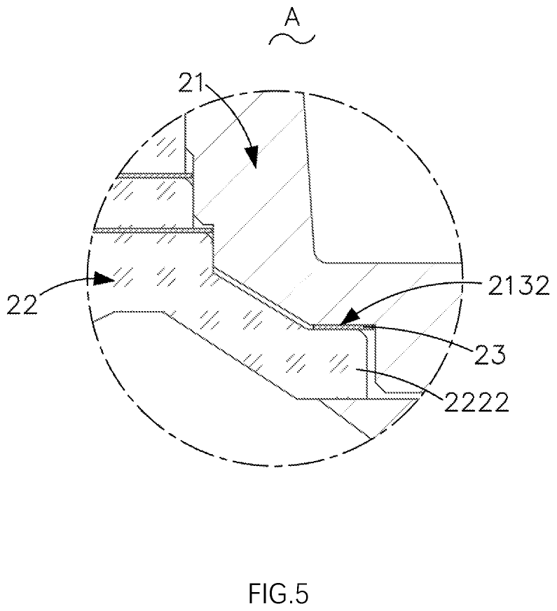

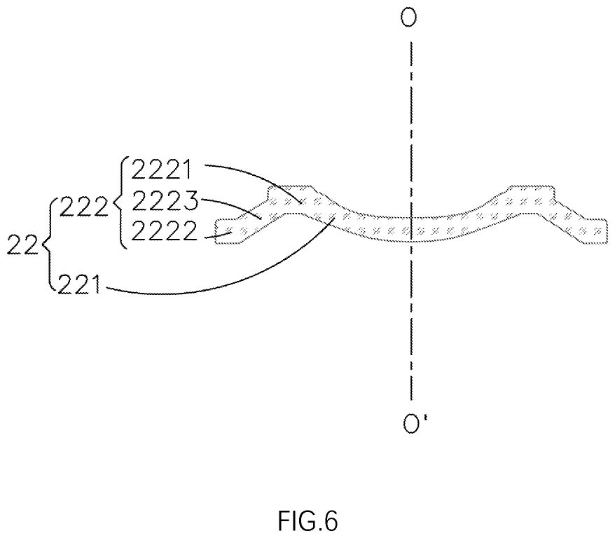

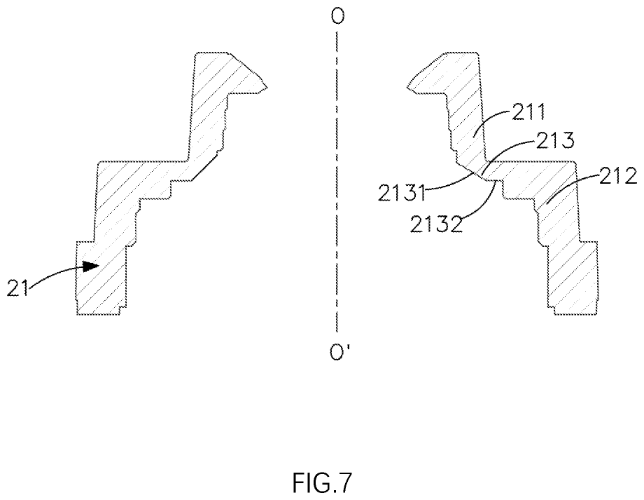

A second embodiment of the present disclosure further provides a lens module 200. As shown in FIGS. 4-7, the lens module 200 includes a lens barrel 21 and a lens 22 arranged inside the lens barrel 22. The lens barrel 21 includes a first barrel wall 211, a second barrel wall 212, and a connection wall 213. The connection wall 213 includes a first inner wall surface 2131 and a second inner wall surface 2132. The lens 22 includes an optical portion 221 and a peripheral portion 222. The peripheral portion 222 includes a first abutting portion 2221, a second abutting portion 2222, and an extension portion 2223. The second embodiment is substantially the same as the first embodiment, and a main difference lies in that, in the first embodiment, the second abutting portion 1222 directly abuts against the second inner wall surface 1132, while in the second embodiment, a light blocking member 23 is arranged between the second abutting portion 2222 and the second inner wall surface 2132.

In this embodiment, it should be noted that the light blocking member 23 is a light shielding sheet, and a thickness of the light blocking sheet can be designed as needed. In this way, a gap between the lens 22 and the second inner wall surface 2132 can be adjusted in such a manner that the lens 22 does not directly contact the lens barrel 21, thereby preventing lens 22 from being in rigid contact with or excessively pressing the second barrel wall 212 during assembly, which would otherwise cause deformation or even damage of the lens 22.

It should be understood by those skilled in the art that the above embodiments are merely some specific embodiments of the present disclosure, and various changes in form and details may be made without departing from the scope of the present disclosure.

What is claimed is:

1. A lens module, comprising:
a lens barrel; and
a lens arranged inside the lens barrel,
wherein the lens barrel comprises:
a first barrel wall extending from an object side towards an image side;
a second barrel wall arranged at an image side of the first barrel wall and having an inner diameter greater than an inner diameter of the first barrel wall; and
a connection wall connecting the first barrel wall with the second barrel wall, and
wherein the lens comprises:
an optical portion for imaging; and
a peripheral portion surrounding the optical portion, the peripheral portion comprising a first abutting portion close to the object side, and a second abutting portion close to the image side and connected to the first abutting portion,
wherein an outer diameter of the second abutting portion is greater than an outer diameter of the first abutting portion, the first abutting portion is received within the first barrel wall, and the second abutting portion is received within the second barrel wall.

2. The lens module as described in claim 1, wherein the first abutting portion abuts against the first barrel wall, and the second abutting portion abuts against the connection wall.

3. The lens module as described in claim 2, wherein the second abutting portion is spaced apart from the second barrel wall.

4. The lens module as described in claim 2, wherein the connection wall comprises:
a first inner wall surface extending from an inner circumference of the first barrel wall close to the image side along a direction facing away from an optical axis and facing towards the image side; and
a second inner wall surface extending from the first inner wall surface to the second barrel wall along a direction perpendicular to and facing away from the optical axis,
wherein the second abutting portion abuts against the second inner wall surface.

5. The lens module as described in claim 4, wherein the peripheral portion further comprises an extension portion connecting the first abutting portion with the second abutting portion.

6. The lens module as described in claim 5, wherein the first inner wall surface is spaced apart from the extension portion.

7. The lens module as described in claim 4, wherein a light blocking member is arranged between the second abutting portion and the second inner wall surface.

8. The lens module as described in claim 1, wherein the first abutting portion comprises an image side surface close to the image side, and the image side surface is a planar surface.

9. The lens module as described in claim 1, wherein the first abutting portion comprises an object side surface close to the object side, and a first abutting surface abutting against the first barrel wall, and an arc transition is arranged between the object side surface and the first abutting surface.
